(19) United States
(12) Patent Application Publication
(10) Pub. No.: US 2022/0051268 A1
(43) Pub. Date: Feb. 17, 2022

(54) Systems and Methods of Indicating Demand

(71) Applicant: Fusion Hotel Management, LLC, San Diego, CA (US)

(72) Inventor: Denny Thakorbhai Bhakta, San Diego, CA (US)

(21) Appl. No.: 16/995,430

(22) Filed: Aug. 17, 2020

(51) Int. Cl. G06Q 30/02; G06Q 10/02; G06Q 50/12; G06F 16/951

(52) U.S. Cl. CPC G06Q 30/0201; G06Q 10/02; G06F 3/14; G06F 16/951; G06Q 50/12

(57) ABSTRACT

This application is directed to systems and methods of gathering booking information on a website, calculating demand based on the booking information, and then displaying that demand value to subsequent website visitors. Demand can be shown as, e.g., a numerical representation or a graphical representation. When users visit a website of the inventive subject matter and submit booking requests, information related to those booking requests can be used in association with calculating demand. In some embodiments, demand can be filtered by duration, location, and other booking attributes.

### FIELD OF THE INVENTION

The field of the invention is demand visualization.

### BACKGROUND

The background description includes information that may be useful in understanding the present invention. It is not an admission that any of the information provided in this application is prior art or relevant to the presently claimed invention, or that any publication specifically or implicitly referenced is prior art.

The hospitality industry has recently experienced some of its most difficult months in recent memory with the emergence of a global pandemic and plummeting demand for hotel rooms. As the economy recovers and tourism begins its slow return to normal, consumers and businesses alike can benefit from new ways to make informed hospitality-based decisions. For example, consumers might be interested in booking a hotel room during a slump in booking demand to get the best possible value for their money, while businesses can benefit from understanding demand as one aspect of their price-setting strategies.

Understanding demand is known, but there nevertheless exists a need in the art for systems and methods that create and display a simple-to-understand demand metric on a publicly available website.

### SUMMARY OF THE INVENTION

The present invention provides systems and methods directed to collecting and displaying demand information via a website. In one aspect of the inventive subject matter, method of displaying a demand measurement on a website is contemplated, the method comprising the steps of: receiving, at a server via the website, booking requests from a first set of client devices visiting the website, wherein each booking request comprises at least one booking attribute; storing, by the server, each booking request to a database; calculating, by the server, the demand measurement using a set of booking attributes stored to the database; and making the demand measurement available for the website to access, wherein upon the second client device visiting the website, the demand measurement is displayed on the second client device.

In some embodiments, the at least one booking attribute includes at least one of a hotel room reservation, a location, and a duration. The at least one booking attribute can include a hotel room reservation. In some embodiments, the demand measurement displayed on the second client device can be a numerical representation and it can also be a graphical representation. It is contemplated that multiple demand representations can be shown simultaneously. In some embodiments, the set of booking attributes relate to booking requests received during a period of time (e.g., a day, a week, a month, etc.).

In another aspect of the inventive subject matter, a method of displaying a demand measurement on a website is contemplated, the method comprising the steps of: visiting a website using a first client device; submitting, to the website via the first client device, a booking request, wherein the booking request comprises a booking attribute; storing, by the server, the booking request to a database, wherein the database comprises a plurality of booking requests collected from other client devices, wherein the plurality of booking requests each comprise at least one booking attribute of the same type as the booking attribute; calculating, by the server, the demand measurement using a set of booking attributes stored to the database; and displaying the demand measurement on a second client device when the second client device accesses the website.

In some embodiments, the booking attribute includes one or any combination of a hotel room reservation, a location, and a duration. The booking attribute can be, e.g., a hotel room reservation. In some embodiments, the demand measurement displayed on the second client device comprises a numerical representation. The demand measurement can also include a graphical representation. In some embodiments, multiple representations of the same or different types are displayed. In some embodiments, the set of booking attributes relate to booking requests received during a period of time such as a day, a week, or a month.

In another aspect of the inventive subject matter, a method of displaying a demand measurement on a website is contemplated, the method comprising the steps of: visiting a website using a first client device; displaying, on the first device via the website, a demand measurement, wherein the demand measurement is calculated by a server using a set of booking attributes stored to a database on the server; submitting, by the first client device via the website, a new booking request, wherein the new booking request comprises a new booking attribute; adding the new booking request to the database; calculating, by the server, an updated demand measurement using a set of booking attributes stored to the database, wherein the set of booking attributes comprises the new booking attribute; and displaying the updated demand measurement on a second client device when the second client device accesses the website.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows how clients can access a website of the inventive subject matter to input booking requests and receive demand information.

FIG. 2 shows an example of how demand information can be displayed.

FIG. 3 shows another example of how demand information can be displayed.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Systems and methods of the inventive subject matter are directed to showing users that access a booking website (e.g., hotel booking) how much demand currently exists for hotel rooms.

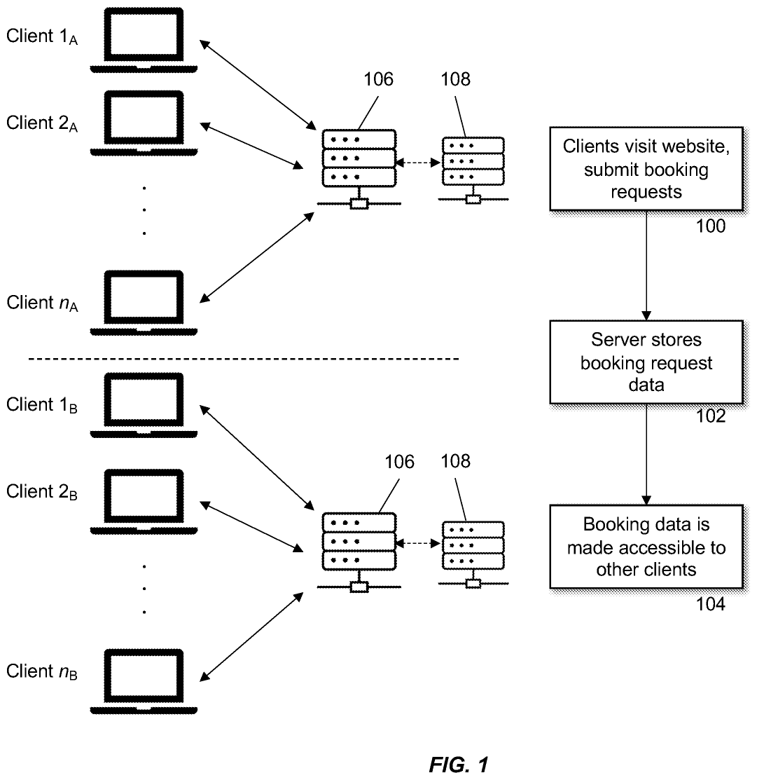

FIG. 1 includes a flowchart showing how systems and methods of the inventive subject matter operate to show website visitors a measure of demand for, e.g., hotel bookings. Embodiments of the inventive subject matter can be directed to a variety of different demand measurements such as rental vehicle demand, vacation rental demand, etc., and although embodiments described in this application are directed to an example featuring hotel room demand, demand for other types of goods or services are also contemplated.

FIG. 1 includes a left side and a right side, where the left sides shows how client devices communicate with a server 106 (or set of servers), and the right side includes flow chart steps. It should be understood in this application that the term “client” refers to a user having a client device, where that client device comprises a computing device having network connectivity. Although client is sometimes pluralized, it should be understood to refer to one or more clients.

In step 100, clients 1_{A}, 2_{A}, . . . , n_{A} visit a website and take an action on that website to submit a booking request. In some embodiments, that action involves filling out and submitting a form on the website. Although the set of clients is shown in FIG. 1 to include clients 1_{A}-n_{A}, this step can feature just a single client accessing the website. Moreover, website access and subsequent client booking request submissions can occur independently of one another (e.g., there is no requirement that client access occur simultaneously). Systems and methods of the inventive subject matter can handle different clients from different locations all making similar booking requests. As clients 1_{A}-n_{A} submit booking requests, those booking requests can be registered and stored in a database stored on a cloud server 108.

A database storing client booking request data can exist on server 106, or, in some embodiments, it can exist on a separate server. For example, server 106 can be configured to host a website that clients 1_{A}-n_{A} visit and submit booking requests to, but information collected via that website is passed from server 106 to, e.g., a cloud server 108 (e.g., Amazon Web Services). Cloud server 108 is shown connected to server 106 by a dotted line as it is an optional feature.

In the context of a hotel booking, client booking data can include many different attributes. It can include, for example, time of booking request, date of booking request, a number of rooms, a number of guests, a number of adults, a number of children, smoking or non-smoking, bed preference, room size preference, hotel preference, location preference, business facility preferences (e.g., conference room space), pool preferences, hot tub preferences, spa preferences, food preferences, and other service-related preferences (e.g., bell hops, etc.). This list is not exhaustive and can include any number of other hotel or hotel room attributes. In some embodiments, a booking request indicates a booking has been finalized (e.g., a client has reserved a room), while in other embodiments a booking request indicates a user has inquired about a booking (e.g., a user has submitted a room inquiry without finalizing a booking). In some embodiments, both actual bookings and booking inquiries are recorded to a database.

As mentioned above, booking data is stored to a database according to step 102. Data stored to that database, which exists either on server 106 or cloud 108, can then be made available to other clients (e.g., either directly or indirectly). Thus, according to step 104, booking data is made accessible to clients accessing the website thereafter. Clients 1_{B}-n_{B}, as shown in step 104, access the website at server 106. Upon accessing the website, clients 1_{B}-n_{B} are presented with a graphical representation of booking data collected from clients 1_{A}-n_{A}. Clients 1_{B}-n_{B} are not required to submit booking requests to server 106 to be shown booking data collected from clients 1_{A}-n_{A}, but those clients are also not prohibited from submitting booking requests.

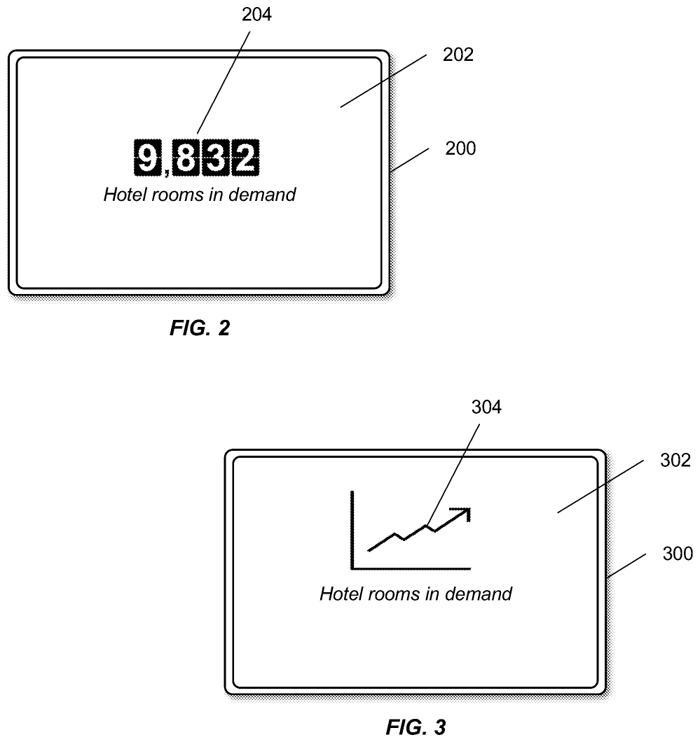

As booking requests are received, the system's database is populated with booking data from each new client. The booking data comprises booking attributes as discussed above, and one or more of those booking attributes can be used to create a visual representation. For example, FIGS. 2 and 3 show example visual representations of booking demand (e.g., hotel room booking demand). FIG. 2 is a display screen 200 showing a website 202 of the inventive subject matter that displays a numerical representation of demand 204, and FIG. 3 is a display screen 300 showing a website 302 of the inventive subject matter that displays a graphical representation of demand 304.

Each representation of demand—and indeed any representation of demand of the inventive subject matter—can take a variety of factors into account. For example, unless demand is restricted to a period of time, it becomes a total demand counter. Thus a graphical or numerical representation of demand can be subject to statistical interpretation to make the measure more useful to clients. For example, numerical demand 204 can show demand during a period of time (e.g., total booking requests over an hour, a day, a week, a month or any period of time therebetween) or average demand (e.g., daily average, weekly average, etc.). In some embodiments, demand can be displayed according to any number of client-supplied attributes that are included with a booking request. For example, a client could be shown demand for hotel rooms based on location (e.g., Honolulu hotel room demand), demand based on resort amenities, etc.

In some embodiments, multiple demand displays can be shown simultaneously, where each demand display can show demand based on a different attribute. For example, a first demand display can show total demand for the week and a second demand display can show demand for the week in a zip code input by a client.

FIG. 3 shows a graphical representation of demand, which can be useful to show a client both current demand as well as historical demand over some period of time (e.g., hour, day, week, month, etc.). As with demand displays discussed above, graphical display of demand 304 can be subject to filtering based on any number of client-supplied attributes that are included with a booking request. In some embodiments, a demand display on a website of the inventive subject matter can be updated in real-time as other clients visit the same website and submit booking requests.

Thus, specific systems and methods directed to collecting and displaying demand information have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of displaying a demand measurement on a website, the method comprising the steps of:
receiving, at a server via the website, booking requests from a first set of client devices visiting the website, wherein each booking request comprises at least one booking attribute;
storing, by the server, each booking request to a database;
calculating, by the server, the demand measurement using a set of booking attributes stored to the database; and
making the demand measurement available for the website to access, wherein upon the second client device visiting the website, the demand measurement is displayed on the second client device.

2. The method of claim 1, wherein the at least one booking attribute comprises at least one of a hotel room reservation, a location, and a duration.

3. The method of claim 1, wherein the at least one booking attribute comprises a hotel room reservation.

4. The method of claim 1, wherein the demand measurement displayed on the second client device comprises a numerical representation.

5. The method of claim 1, wherein the demand measurement displayed on the second client device comprises a graphical representation.

6. The method of claim 1, wherein the set of booking attributes relate to booking requests received during a period of time.

7. The method of claim 6, wherein the period of time comprises at least one of a day, a week, and a month.

8. A method of displaying a demand measurement on a website, the method comprising the steps of:
visiting a website using a first client device;
submitting, to the website via the first client device, a booking request, wherein the booking request comprises a booking attribute;
storing, by the server, the booking request to a database, wherein the database comprises a plurality of booking requests collected from other client devices, wherein the plurality of booking requests each comprise at least one booking attribute of the same type as the booking attribute;
calculating, by the server, the demand measurement using a set of booking attributes stored to the database; and
displaying the demand measurement on a second client device when the second client device accesses the website.

9. The method of claim 1, wherein the booking attribute comprises at least one of a hotel room reservation, a location, and a duration.

10. The method of claim 1, wherein the booking attribute comprises a hotel room reservation.

11. The method of claim 1, wherein the demand measurement displayed on the second client device comprises a numerical representation.

12. The method of claim 1, wherein the demand measurement displayed on the second client device comprises a graphical representation.

13. The method of claim 1, wherein the set of booking attributes relate to booking requests received during a period of time.

14. The method of claim 13, wherein the period of time comprises at least one of a day, a week, and a month.

15. A method of displaying a demand measurement on a website, the method comprising the steps of:
visiting a website using a first client device;
displaying, on the first device via the website, a demand measurement, wherein the demand measurement is calculated by a server using a set of booking attributes stored to a database on the server;
submitting, by the first client device via the website, a new booking request, wherein the new booking request comprises a new booking attribute;
adding the new booking request to the database;
calculating, by the server, an updated demand measurement using a set of booking attributes stored to the database, wherein the set of booking attributes comprises the new booking attribute; and
displaying the updated demand measurement on a second client device when the second client device accesses the website.
